(19) United States
(12) Patent Application Publication
(10) Pub. No.: US 2010/0101595 A1
(43) Pub. Date: Apr. 29, 2010

(54) Hair Treatment Application Device

(76) Inventors: Robert Wayne Glenn, JR., Liberty Township, OH (US); Paul Edmund Baker, Silchester (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/581,476

(22) Filed: Oct. 19, 2009

(30) Foreign Application Priority Data
Oct. 29, 2008 (EP) 08167797.3

(51) Int. Cl. A61Q 5/10; A45D 24/16; A45D 19/00

(52) U.S. Cl. 132/208; 132/120; 132/270

(57) ABSTRACT

A hair treatment application device is provided herein, comprising a first plate and a second plate positionable in a juxtaposed relationship when said hair treatment application device is in a closed state. The hair treatment application device is characterized by having a fluid containment means, which extends from the internal surface of said first plate upwards to provide an internal surface and an external surface of said fluid containment means, whereby said internal surface of said fluid containment means and said internal surface of said first plate define a fluid containment zone for accommodating a hair treatment composition. The hair treatment application device comprises a fluid control means, which extends upward from the internal surface of said second plate. The fluid control means of said second plate surrounds said fluid containment means of said first plate when said hair treatment application device is in a closed state.

### FIELD OF THE INVENTION

The present invention relates to a hair treatment application device which allows for easy, precise, and non-messy targeted application of cosmetic compositions to various substrates, such as hair. The application device according to the invention is especially intended for hair treatment compositions.

### BACKGROUND OF THE INVENTION

To accommodate for changes in fashion and style and to provide masking of the first grey hair, more and more consumers have the desire to alter the colour or style of their hair. In particular, many consumers have the desire to perform treatments to selected hair strands, rather than all of their hair to create more natural looking effects. For example, consumers can apply styling, coloring or bleaching compositions to selected hair strands to produce hair strand effects. An example of such a composition, and visual effect is the process of hair highlighting, wherein selected hair strands are lightened at least one shade lighter than the rest of the hair. To achieve a personal customization of the end-look, the consumer can choose to perform highlighting by employing home highlighting kits or may visit a professional stylist.

Professionals have a number of devices and techniques at their disposal which together with training and years of experience allow the variety of results expected by consumers to be delivered. However, due to the accuracy and length of the process, the consumer is required to regularly spend a number of hours at the salon in order to complete the process. Because of the long time and effort employed by the professionals to achieve the expected end results, a high premium is also demanded by the professional stylists for their services.

The home highlighting product market is vast, financially accessible to consumers and offers various products to practically deliver bleach to the hair. However, a number of drawbacks are associated with using home hair highlighting treatments without assistance of a professional and some attempts to address these problems are known in the art.

Application articles composed of multiple layers of different materials as well as sponges able to deliver cosmetic compositions are generally known. The combination of such application articles with devices or tools is also known. One example is an applicator comprising a cylinder-shaped reservoir for containing a hair treatment composition, wherein said reservoir has a lateral opening where an elastic deformable material is lodged. Through that opening the hair strand is set into communication with the composition contained in the reservoir. Another example is an applicator comprising an applicator portion and a fastening means. The applicator portion comprises an elastically compressible container where the hair treatment composition is lodged. The user positions a hair strand between one finger and the container. Upon application of pressure on the compressible container, the composition contained therein is released on the hair strand. Other examples include hair cosmetic applicators which have two hinged plates each carrying bags comprising hair treatment compositions. Applicators comprising two interlocking hinged plates covered with an absorbent material are also known and work as a replacement for foils which are used by stylists in professional salons.

It is generally known that self-application of strand effect compositions are difficult, and that it will be made even more complicated if an inappropriate application device is used. An applicator device capable of facilitating the self-applications of hair treatment compositions needs to be conceived to consider and address several technical challenges to achieve the expected highlighting end results in a clean and tidy manner.

First of all, the application of hair treatment compositions at the back of the head is complicated as it requires the user to select hair strands by judging from a mirror image. The more complicated the strand selection and subsequent application is, the longer the user is obliged to maintain the arms over the head, creating discomfort and affecting the overall results.

Furthermore, applicators for self-application of hair strand effects should be designed to prevent leaking and oozing of the hair composition from the applicator during the application experience. Some hair strand effect compositions due to their unpleasant nature, such as highlighting compositions, may ruin a consumer's home surfaces and clothes, if such compositions are dripped onto them. But leaking and oozing are not unwanted only for cleanliness purposes; they are also unwanted in order to enable a precise, clean and fashionable application.

For a hair strand effect composition to achieve the expected end result, it is necessary for the composition to be precisely applied where desired. Even a little amount of hair composition at the edge of the applicator may provide unexpected results as it could easily be transferred from the selected hair strand to unselected ones, thus disrupting the desired pattern. This problem may also occur at the root-line, where random lighter patches at the root of the hair can provide an unanticipated and undesired final overall appearance.

Finally, an applicator for a hair treatment composition should be easy to use; it should not require any special experience and training in matters such as how much and where to load the hair treatment composition. The more complicated the applicator is to be loaded, the more uncomfortable the user will feel in using the applicator, especially for hair treatment compositions such as highlighting, colouring and perming compositions which impart a permanent result.

Thus, what still remains unsolved is the provision of a hair treatment applicator to satisfy the home hair strand effect consumers' needs in terms of avoiding the leaking of the composition from the applicator and easiness to use with one hand, to pick up, grip, hold and lay down. Moreover, the applicator should be easy to guide through the hair particularly at the root line and to perform several applications irrespective of the hair length. The applicator should provide flexibility for creating a high variety of highlights and new fashions, for shortening the time and for simplifying the highlight process. Finally, the applicator should doubtless be light, cheap, disposable or recyclable and easy to produce.

It has now been found that a hair treatment application device (as defined herein after) can significantly improve the highlighting results at home as well as at professional salons.

### SUMMARY OF THE INVENTION

According to the invention, a hair treatment application device (1) is provided, said device (1) comprising a first plate (10) and a second plate (20) positionable in a juxtaposed relationship when said hair treatment application device (1) is in a closed state, said first (10) and second plates (20) being coupled together via a connection (30), said first (10) and second plates (20) each has an internal (101; 201) and external (102; 202) surface and said first (10) and second plates (20) each has a perimeter edge (103; 203), characterized in that said device (1) further comprises:
a. a fluid containment means (40), which extends from said internal surface (101) of said first (10) plate upwards to provide an internal surface (401) and an external surface (402) of said fluid containment means (40), whereby said internal surface (401) of said fluid containment means (40) and said internal surface (101) of said first plate (10) define a fluid containment zone (104) for accommodating a hair treatment composition; and
b. a fluid control means (50), which extends upward from the internal surface (201) of said second (20) plate; wherein said fluid control means (50) of said second plate (20) surrounds said fluid containment means (40) of said first plate (10) when said hair treatment application device (1) is in a closed state.

The present invention further relates to methods of treating the hair with said hair treatment application device (1) and kit-of-parts comprising said hair treatment application device (1).

### BRIEF DESCRIPTION OF THE DRAWINGS

FIG. 1 is a perspective view of one embodiment of the hair treatment application device (1) according to the present invention. The hair treatment application device (1) has a first (10) and second (20) plate, coupled together by a connection (30). Each (10; 20) plate has an internal (101; 201) and external (102; 202) surface and a perimeter edge (103; 203). The first plate (10) has on the internal surface (101) a fluid containment means (40) which extends upwards from said internal surface (101) of said first plate (10) upwards to provide an internal surface (401) and an external surface (402) of said fluid containment means (40), whereby said internal surface (401) of said fluid containment means (40) and said internal surface (101) of said first plate (10) define a fluid containment zone (104). The second (20) plate has on the internal surface (201) a fluid control means (50). The fluid containment means (40) and the fluid control means (50) in this embodiment are characterized by being a continuous strip of a material. The outer side (55) of said fluid control means (50) comprises an impervious membrane.

FIG. 2 is a perspective view of one embodiment of the hair treatment application device (1) according to the present invention. The hair treatment application device (1) has a first (10) and second (20) plate, coupled together by a connection (30). The fluid containment means (40) and the fluid control means (50) in this embodiment are characterized by being a continuous strip of a material. The fluid control means (50) extends at the perimeter edge (203) of said second plate (20).

FIG. 3 is a perspective view of one embodiment of the hair treatment application device (1) according to the present invention. The hair treatment application device (1) has a first (10) and second (20) plate, coupled together by a connection (30). The fluid control means (50) in this embodiment is characterized by being a continuous strip of a material whereas the fluid containment means (40) is characterized by being a group of tines, circularly distributed on the internal surface (101) of said first plate (10). Said circular distribution of tines defines a fluid containment zone (104) on said internal surface (101).

FIG. 4 is a perspective view of one embodiment of the hair treatment application device (1) according to the present invention. The hair treatment application device (1) has a first (10) and second (20) plate, coupled together by a connection (30). The fluid control means (50) in this embodiment is characterized by comprising bundles of bristles organized at the perimeter edge (203) of the second plate (20) to form a ring whereas the fluid containment means (40) is characterized by being discontinuous and is provided by multiple distinct arcs of material which together form a circumference. Said circumference confines the fluid containment zone (104) on the internal surface (101) of said first plate (10).

FIG. 5 is a cross-section view of one embodiment of the hair treatment application device (1) according to the present invention. The hair treatment application device (1) has a first (10) and second (20) plate, coupled together by a connection (30). The fluid control means (50) extends to the perimeter edge (203) of said second plate (20). The fluid containment means (40) and the fluid control means (50) in this embodiment are characterized by being a continuous strip of a material. The portion of said first plate (10) where the fluid containment zone (104) is located comprises a concave depression or cavity formed in said first plate (10).

### DETAILED DESCRIPTION OF THE INVENTION

The present invention is characterized by the synergistic relationship and joint contribution that the fluid containment means (40) and fluid control means (50) as described herein have when combined together in the specific interrelation selected within the scope of the present invention to solve the above described technical problem.

To achieve the expected technical effect, the hair treatment application device (1) comprises a first (10) and a second (20) plate coupled together via a connection (30) to allow the user to guide the hair treatment application device (1), with the use of either hand, precisely and easily to the section of hair to be treated including the hard to reach areas such as at the back of the head or hair close to the scalp. The fluid containment means (40) defines on the internal surface (101) of said first plate (10) a fluid containment zone (104) that provides the applicator device (1) with an indication of where to load the hair treatment composition. The fluid control means (50), which surrounds the fluid containment means (40) when said first (10) and second (20) plates are brought into juxtaposed relationship by pivoting them about the connection (30) prevents the formation of blobs and drops of hair treatment composition and helps to prevent excessive deposition of these blobs and drops of hair treatment composition during the application of the same onto the hair.

The combination of all these features allows the delivery of a hair treatment composition to the selected hair strands in a homogeneous, non-messy and clean fashion.

For the purpose of this invention, the term hair refers to both living hair i.e. on a living body and to non-living hair i.e. in a wig, hairpiece or other aggregation of non-living keratinous fibre. Mammalian, preferably human hair is intended.

The term hair strand, for the purpose of this invention, refers to at least two keratinous fibres, especially hair, in particular human hair and it should be construed as a hair bundle.

As used herein, the terms applied, accommodated, coated, loaded, absorbed, adsorbed and adhered are all referring to a hair treatment composition into or onto the hair treatment application device (1) according to the invention.

While the specification concludes with claims, which particularly point out and distinctly claim the invention, it is believed the present invention will be better understood from the following description.

### 1. Plates

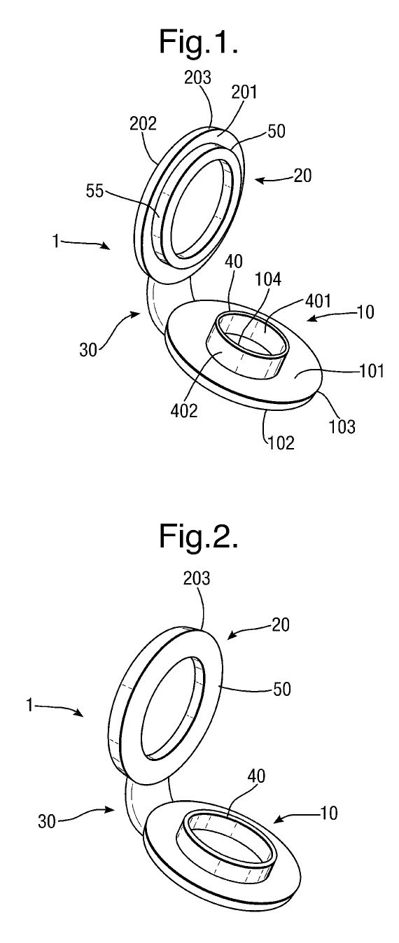

The hair treatment application device (1) of the present invention comprises a first (10) and a second (20) plate; both plates (10; 20) are of ergonomic size and can thus fit easily on either hand. The shape of the plates may vary. Rectangular, square, circular, elliptical or oblong shapes may be useful as they are easy to manufacture but other shapes, particularly those that are easily recognised by the consumers may be used. As shown in FIG. 1, each plate (10; 20) of said hair treatment application device (1) comprises an internal (101; 201) and external surface (102; 202). The internal surface (101, 201) of said first and/or second plate (10; 20) may further comprise one or more areas, which have visible or tactile differences from said internal surfaces (101; 201). Said visible or tactile differences comprise differences in colour or shade, differences in patterns, markings or embossments.

The internal (101; 201) and external surface (102; 202) of each plate (10; 20) may be independently flat or curved, preferably the external surfaces (102; 202) are curved. Each plate (10; 20) or at least a portion thereof may comprise one or more cavities, preferably one or more concave cavities or one or more V-shaped grooves, U-shaped grooves or combinations thereof Said cavities or grooves may be independently located on the internal (101; 201) or external (102; 202) surface of either or both plates (10; 20). Each plate (10; 20) may be of the same or different size and shape.

Each plate (10; 20) may be independently manufactured from any known material or combination of materials capable of supporting a hair treatment composition. Suitable materials are polymer resins such as a polyolefin e.g. polypropylene, polyethylene or polyethylene terephthalate. Other materials which could be used include polyvinylchloride, polyamide, acetyl, acrylonitrile butadiene styrene, acrylic, acrylonitrile styrene acrylate, ethylene vinyl alcohol, polycarbonate, polystyrene, silicone or thermo plastic elastomer, thermo plastic vulcanate or copolymers where appropriate; flexible pliable substrates such as paper boards, metal based substrates and aluminium foils, filmic substrates or multiple laminations or combinations of multiple layers of said materials.

### 2. Connection

The selection of a connection (30) to couple together the first (10) and the second (20) plates improves the user's perception of control over the hair treatment application device (1) and allows the user to guide the hair treatment application device (1), with the use of either hand, precisely and easily and also allows access to hard to reach sections, such as the back of the head or hair close to the scalp. In addition, the connection (30) allows the user to move the hair treatment application device (1) from one bundle of hair strands to another without having to adjust the position of the first (10) plate onto the second (20) plate after each application.

The connection (30) between the two plates (10; 20) according to the present invention allows the hair treatment application device (1) to be in a closed state or in an open state. When the hair treatment application device (1) is in a closed state, said first plate (10) is in juxtaposed relationship to said second plate (20), whereas when the hair treatment application device (1) is in an open state, the angle between said internal surfaces (101; 201) of said first and second plates (10; 20) may range between 5° and 360°. The characteristics of the connection (30) may be an intrinsic property of the material used to manufacture the connection or may be provided by the design of the connection itself. The connection (30) should not break or get damaged so as to affect utility within a few applications.

### 3. Fluid Containment Means, Fluid Containment Zone And Fluid Control Means

The fluid containment means (40) extends upward from the internal surface (101) of said first plate (10) to provide and internal surface (401) and an external surface (402) of said fluid containment means. The internal surface (401) of the containment means and the internal surface (101) of said first plate (10) provides the application device (1) with a means to contain the hair treatment composition within the device (1) as it confines a portion of said internal surface (101) of the plate where the hair treatment composition may be loaded. This portion confined by the fluid containment means (40) is the fluid containment zone (104). Additionally, the fluid containment means (40) may help the user by indicating the amount of hair treatment composition which needs to be loaded to perform a hair treatment or part thereof.

The fluid control means (50) extends upwards from the internal surface (201) of said second plate (20) as shown in all the figures. The fluid control means (50) comprises an internal side which faces the fluid containment means (40) when said application device (1) is in a closed state, and an outer side (55). The fluid control means (50) provides the hair treatment application device (1) with an excellent measure to avoid messiness during the application of a hair treatment composition, preventing the formation of blobs or drops of hair treatment composition at the perimeter edges (103; 203) of the plates (10; 20) when the hair treatment application device (1) is brought in the closed state. Blobs may results in the deposition of an excessive amount of hair treatment composition onto the hair, especially close to the roots. Blobs of hair treatment composition may also bleed across other hair strands causing unacceptable and unsightly treatment in neighbouring strands. Bleeding across other hair strands may also be accompanied by skin irritation if the hair treatment composition reaches the scalp.

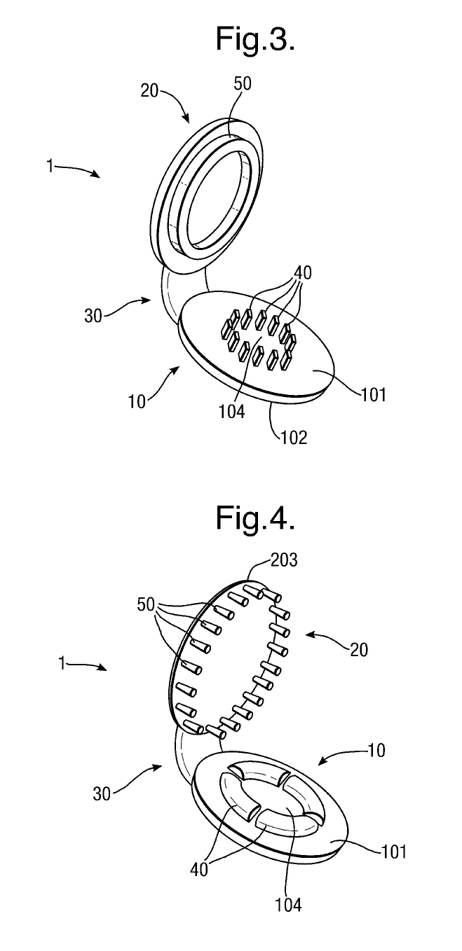

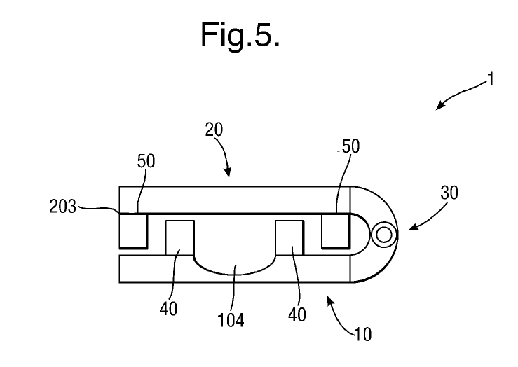

The fluid containment means (40) and the fluid control means (50) may independently comprise a material selected from a porous compressible material, a porous non-compressible material, a non-porous compressible material, a non-porous non-compressible material or combinations thereof. Preferably, the containment means (40) comprises a material selected from a porous compressible material, a non porous compressible material or tines or bristles or mixtures thereof. Furthermore, they may also comprise tines or bristles used alone or in combination with the materials described above. FIG. 3 shows an embodiment according to the invention wherein the fluid containment means (40) is formed by a group of tines circularly distributed on the internal surface (101) of said first (10) plate, said annular distribution of tines providing said internal (401) and external (402) surface of the fluid containment means (40) thereby confining a fluid containment zone (104) on said internal surface (101) of said first (10) plate. FIG. 4 shows another embodiment according to the invention wherein the fluid control means (50) is characterized by comprising bundles of bristle organized to form a ring at the perimeter edge (203) of said second plate (20).

The fluid containment means (40) and fluid control means (50) can be described in terms of their length and width upon the internal surfaces (101, 201) of the first (10) and second (20) plates. The length refers to the distance of the fluid containment means (40) or fluid control means (50) external surface (402) or outer side (55) which are in contact with the respective internal surfaces (101, 201). For embodiments where either the fluid containment means (40) and fluid control means (50) are in the form of bristles or tines, or as discrete islands the length is measured as the shortest continuous distances around the outer side (55) or external surface (402) in contact with the respective internal surfaces (101, 201) of the plates. The fluid containment means (40) and fluid control means (50) may have a length of from about 1 cm to about 80 cm, preferably from about 3 cm to about 50 cm and more preferably from about 6 cm to about 30 cm. The width refers to the distance between the internal and external surfaces (401,402) of the fluid containment means (40) and the outer side (55) and the internal side of the fluid control means (50). This width may be about constant or variable. For embodiments where the width is about constant, the fluid containment means (40) and fluid control means (50) are continuous, said fluid containment means (40) and fluid control means (50) have a width of from about 0.05 cm to about 4.00 cm, preferably from about 0.10 cm to about 3.00 cm, more preferably from about 0.50 cm to about 2.50 cm. For embodiments where the width is variable, as for example in the case of tines or bristles, or wherein the containment means (40) or control means (50) it may range from 0.00 cm, in the regions where there is no material to about 4.00 cm, preferably from about 0.00 cm to about 3.00 cm, more preferably from about 0.00 cm to about 2.50 cm. Wherein at least one region around the containment means (40) and control means (50) has a width of at least 0.05 cm.

In certain embodiments the outer side (55) of said fluid control means (50) as shown in FIG. 1 may further comprise an impervious membrane. In certain embodiments the fluid containment means (40) and the fluid control means (50) are both a continuous strip of a non-porous compressible material. In certain preferred embodiments, the fluid containment means (40) and the fluid control means (50) are both a continuous strip of a porous compressible material. Preferably, said porous compressible material is one or more non-wovens, one or more foams or a combination of one or more non-wovens with one or more foams.

The fluid control means (50) surrounds the fluid containment means (40) when said first (10) and second (20) plates are brought into juxtaposed relationship by pivoting them about the connection (30) and the hair treatment application device (1) is brought into a closed state. In certain embodiments, the fluid containment means (40) is spatially separated from the fluid control means (50), whereas in certain other embodiments the fluid containment means (40) is substantially adjacent to the fluid control means (50).

In certain embodiments the space between the perimeter edge (103) of said first plate (10) and the fluid control means (104) may accommodate additional features as described later below.

In certain preferred embodiments, the fluid control means (50) extends substantially along said perimeter edge (203) of said second plate (20) or is substantially adjacent to said perimeter edge (203) of said second plate (20) as shown in FIG. 2.

Suitable porous compressible or non-compressible materials for said fluid containment means (40), fluid control means (50) and fluid containment zone (104) may be selected from non-wovens; wovens; porous foams and foam materials; porous plastics; flexible frits; meshes; sponges and combinations thereof including recycled and composite materials having one or more plies of the same or different materials superimposed physically, joined together continuously (laminated), in a discontinuous pattern, or by bonding the external edges at discrete loci provided that the structures meet the functional requirements described hereinabove.

Useful non-porous compressible material comprises materials such as silicone or natural and synthetic rubbers, thermo plastic elastomer, thermo plastic vulcanate or copolymers or other suitable flexible thermoplastic materials including polyolefins, polyvinylidene chloride and polystyrene. Other suitable examples include, but are not limited to, ethylene-propylene diene monomer rubbers, halogenated polyolefins, hydrogenated adduct of a styrene-butadiene block copolymer with maleic anhydride, and SEBS (sequenced styrene-ethylene-butadiene) polymers.

Suitable non-porous non-compressible materials may include other polymer grades of polyolefin's (such as polyethylene, or polypropylene). Other polymers could be used including polyvinylchloride, polyamide, acetyl, acrylonitrile butadiene styrene, acrylic, acrylonitrile styrene acrylate, ethylene vinyl alcohol, polycarbonate, polystyrene, or copolymers.

Suitable materials for tines include polymers such as those described herein for manufacture of the plates.

Suitable materials for bristles include polymers such as those described herein for manufacture of the plates. The wire form of the bristles or brushes may be straight, curved or crimped to achieve the required performance.

The materials listed above can be co-injected, over moulded, in-mold assembled, or attached by adhesion lamination, heat bonding and they may be removable or permanently attached. Any methods suitable to attach the material to the internal surfaces (101; 201) of the hair treatment application device (1) may be employed herein providing that said method does not destroy or alter the performance of said material.

Suitable materials for an impervious membrane include polymers such as those described herein for manufacture of the plates and sealed non-wovens or sealed foam structures.

### 4. Additional Features

A detailed description of some additional features useful to be combined with the essential features according to the present invention is given below. These additional features may be optionally located on the internal (101; 201) or external (102; 202) surfaces of said first (10) and second (20) plates. Preferably, some of these features may be located on the internal surfaces (101; 201) of said plates (10; 20) and may be interposed between said fluid containment means (40) and fluid control means (50) when said plates (10; 20) are brought into a juxtaposed relationship. Within the scope of the present invention are also conceived the combinations of the additional features described herein below within the same hair treatment application device (1).

4.1 Reservoirs

The hair treatment application device (1) may further comprise a reservoir for a hair treatment composition, wherein said reservoir communicates with said fluid containment zone (104). The reservoir may be present on the external or internal surface (101; 102) of the first plate (10). Preferably, the reservoir communicates with said fluid containment zone (104) in the internal surface (101) through apertures located through said plate (10). A valve may be located on the reservoir. The reservoir may be fixed, attachable or removable from the plate (10) and may be disposed of once the hair treatment compositions have been released.

4.2 Stop Mechanism

One or more stop mechanisms may be incorporated onto at least one of the internal surfaces (101; 201) of said first and second plate (10; 20). The stop mechanism ensures that the hair treatment composition may not be forced beyond the perimeter edge (103; 203) of said first and second plates (10; 20). In certain embodiments, the hair treatment application device (1) is brought into a closed state by applying pressure on the external surfaces (102; 202) of the plates (10; 20). When a too high pressure is exerted on the external surfaces (102; 202) of said first and second plates (10; 20) to bring the same into a juxtaposed relationship, the hair treatment composition may bleed out from the hair treatment application device (1) or it may form blobs leading to unacceptable mess. Too high pressure may even cause damage to the materials comprised in said fluid containment means (40), fluid control means (50), fluid containment zone (104), if present, affecting the application of the hair treatment composition to the hair.

4.3 Hair Strand Selection Means

Consumers may use their fingers to select the hair strands on which they desire to apply the hair treatment composition. The hair treatment application device (1) of the present invention may however be further provided with hair strand selection means. Examples of hair strand selection means are, but not limited to, spikes, hooks, crochets, clips or beads. The hair strand selection means may be incorporated in one or both plates (10; 20). Said means may also be attached through a snap mechanism to the plates (10; 20) such that the hair strand selection means may swing from a position proximal to the plate to a far one, such as it happens with the blades of a penknife. The hair strand selection means may also be separately provided to the hair treatment application device (1) of the present invention as a component of a kit-of-parts as described herein below.

4.4 Gripping Areas

Usually consumers wear gloves during the application of the hair treatment composition. The gloves are typically made from materials such as poly vinyl chloride or polyethylene or rubber materials such as isoprene, nyoprene or latex and may increase the difficulty for the consumers to grip the hair treatment application device (1). Thus, the hair treatment application device (1) disclosed herein may further comprise on the external surfaces (102; 202) of one or both plates (10; 20) gripping areas that are designed to provide grip.

### 5. Method of Use

The present invention also relates to a method to treat the hair by contacting the hair with the hair treatment application device (1) according to the invention. Said hair treatment application device (1) may be pre-loaded with one or more hair treatment compositions, but preferably said hair treatment application device (1) is loaded by the user with said at least one or more hair treatment compositions before contacting the hair with said hair treatment application device (1).

The hair treatment composition can be loaded onto the application device (1) by any means. In one embodiment the hair treatment composition is loaded directly onto the fluid containment zone (104) by applying the hair treatment composition for example with a spatula, a syringe, by a squeezable tube or by a dispensing bottle. When an optional reservoir is present the hair treatment composition may be loaded into said reservoir through a one-way or a two-way valve.

When the hair treatment compositions require mixing and activation prior to application to the hair, the components of the hair treatment compositions may be mixed by shaking or stirring before loading or can be mixed during the loading procedure by employing specialized two or multi-chambered containers coupled with a static mixer. The mixing may also be performed by interposing an additional means capable of mixing two or more hair treatment compositions or capable of mixing powders with water or other solvents to make a hair treatment composition. Said interposed means can also be provided with features to inject or load the mixed hair treatment compositions onto the hair treatment application device (1).

When two or more hair treatment compositions require mixing before application, said two or more hair treatment compositions are loaded, either together or subsequently, into said fluid containment zone (104).

Multiple or subsequent loading may be accomplished by positioning, the application device (1) in a tray or by connecting or attaching the application device (1) to multi-chambered bottles, tubes or other applicators capable of dispensing either the single or the total amount of the hair treatment composition needed.

The amount of hair treatment composition loaded on the application device (1) depends upon its size and capacity and the desired end results.

Once the hair treatment application device (1) is loaded with at least one hair treatment composition, the same is delivered by contacting the hair treatment application device (1) with the hair. The user holds through the external surfaces (102; 202) of said first and second plates (10; 20) the hair treatment application device (1) in one hand, preferably between the thumb and the index finger. Once the user has selected the hair strands to be treated, the hair treatment application device (1) is positioned onto the hair strands, preferably at the root line while the hair treatment application device (1) is in an open state. The internal surfaces (101; 201) of the application device (1) are then clamped around the hair strands by bringing the plates (10; 20) into a juxtaposed relationship. By keeping the hair treatment application device (1) in this closed state, the user applies the hair treatment composition by swiping the hair treatment application device (1) along the entire length of the selected hair strands. The hair treatment composition may also be applied only to limited areas of the hair, i.e. the user can coat only the root-line with the hair treatment composition. These steps, including the steps of loading the application device (1) as described above may be repeated more than once.

By contacting the hair with the hair treatment application device (1) once the same is loaded with one or more hair treatment composition, the hair treatment composition is delivered to the hair.

In a preferred embodiment said one or more hair treatment compositions comprise a first and second hair treatment compositions and said first and second hair treatment compositions are mixed to form a third hair treatment composition. Said third hair treatment composition is loaded on said hair treatment application device (1) before contacting the hair with said hair treatment application device (1). In this preferred embodiment, said first hair treatment composition comprises an oxidizing agent, whereas said second hair treatment composition comprises an alkalizing agent and a persulfate salt. In the most preferred embodiment, said oxidizing agent comprises hydrogen peroxide and said alkalizing agent comprises a component selected from, sodium metasilicate, solidum silicate, ammonium chloride and mixtures thereof When said first and second hair treatment compositions are mixed together, they form a highlighting composition.

The hair treatment compositions according to the present invention are not intended to be applied to hair in a stationary manner but rather they are moved against the hair surface with the use of shear forces, i.e., swiping of individual hair strands, rubbing along root-line, rubbing into hair, wiping surface of hair, pulled through hair etc., thereby depositing the hair treatment composition evenly along the entire length of the hair as required.

In certain embodiments a first hair treatment composition is applied to the hair via any of the known conventional methods as a pre- or post-treatment to a second any further hair treatment composition which can be applied via the hair treatment application device (1) according to the present invention.

Finally, the application of the hair treatment composition may occur on wet or dry hair and optionally, a rinsing or a shampooing step can be included between application of the first and second compositions to the hair.

### 6. Kit-of-Parts

The hair treatment application device (1) according to the present invention may be provided as a component of a kit-of-parts. The kit-of-parts according to the present invention may also comprise more than one hair treatment application device (1). Additionally, the kit-of-parts may comprise at least one or more individually packaged hair treatment compositions comprising shampoo compositions, conditioning compositions, styling compositions, hair colourant compositions, hair bleaching, highlighting compositions or combination thereof

In one embodiment of the present invention, a first individually packaged hair treatment composition may comprise an oxidative dye precursors and an alkalizing agent whereas a second individually packaged hair treatment composition may comprise an oxidizing agent. In a preferred embodiment of the present invention the kit-of-parts further comprises an individually packaged composition comprising an oxidizing agent and an individually packaged composition comprising an alkalizing agent. Preferably said oxidizing agent is hydrogen peroxide. More preferably, at least one of said individually packaged hair treatment composition comprises a persulfate salt.

Additional individually packaged hair treatment compositions may be present in the kit-of-part and may comprise components such as oxidizing agents, conditioners, chelants, radical scavengers, solvents, direct dyes, shampoo, buffering agents, colouring agents thickeners, enzymes, anionic, nonionic, amphoteric and cationic surfactants, carriers, antioxidants, stabilizers, perfumes, masking fragrances, herb and plant extracts, pearlescent, opacifiers, hair swelling agents and/or polymers, humectants, moisturizers, viscosity enhancers, gelling agents, chelators, UV filters, antimicrobials, preservatives, proteins or mixtures thereof

The kit-of-parts according to the present invention may further comprise additional components such as means to select the hair strands, means to load the application device (1) according to the present invention, means to mix and/or load said individually packaged hair treatment compositions, combs or brushes, gloves, caps with holes, tweezers, tongues, hooks or combination thereof

### 7. Hair Treatment Compositions

Examples of hair treatment compositions that may be loaded into the hair treatment application device (1) according to the invention are hair treatment compositions comprising components known, conventionally used, or otherwise effective for the use in creating a hair strand effect, such as oxidative bleaching and hair coloring compositions.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A hair treatment application device comprising a first plate and a second plate positionable in a juxtaposed relationship when said hair treatment application device is in a closed state, said first and second plates being coupled together via a connection, said first and second plates each has an internal and external surface and said first and second plates each has a perimeter edge, characterized in that said device further comprises:
a. a fluid containment means, which extends from said internal surface of said first plate upwards to provide an internal surface and external surface of said fluid containment means, whereby said internal surface of said fluid containment means and said internal surface of said first plate define a fluid containment zone to contain a hair treatment composition therein; and
b. a fluid control means, which extends upward from the internal surface of said second plate;
wherein said fluid control means of said second plate surrounds said fluid containment means of said first plate, when said hair treatment application device is in a closed state.

2. A device according to claim 1, wherein said fluid containment means and said fluid control means independently comprise materials selected from the group consisting of porous compressible materials, porous non-compressible materials, non-porous compressible materials, non-porous non-compressible materials, tines, bristles and combinations thereof.

3. A device according to claim 2, wherein said fluid containment means comprises tines, bristles, teeth, or mixtures thereof.

4. A device according to claim 2, wherein said fluid control means is a continuous strip of porous compressible material.

5. A device according to claim 1, wherein said fluid control means comprises an internal side which faces said fluid containment means when said application device is in a closed state, and an outer side, wherein said outer side of said fluid control means comprises an impervious membrane

6. A device according to claim 1, wherein said internal or external surface of said fluid containment means is substantially continuous.

7. A device according to claim 1, wherein said fluid control means extends along the perimeter edge of said first plate.

8. A device according to claim 1, wherein said fluid containment means is substantially adjacent to said fluid control means when said device is in a closed state.

9. A device according to claim 1, wherein at least a portion of said first plate, comprises a depression.

10. A device according to claim 1, wherein said connection is a hinge.

11. A method to treat hair comprising loading a device according to claim 1, with at least one hair treatment composition, and then contacting the hair with said hair treatment application device.

12. A method according to claim 11, wherein said at least one hair treatment composition comprises a first and a second hair treatment compositions, wherein said first hair treatment composition comprises an oxidizing agent and said second hair treatment composition comprises an alkalizing agent and a persulfate salt, and wherein said first and second hair treatment compositions are mixed to form a third hair treatment composition and wherein said third hair treatment composition is loaded on said hair treatment application device before contacting the hair with said hair treatment application device.

13. A method according to claim 11, wherein said first plate and second plate are brought into juxtaposed relationship at least once before contacting the hair with said hair treatment application device.

14. A kit-of-parts comprising at least one hair treatment application device according to claim 1.

15. A kit-of-parts according to claim 14, wherein said kit comprises at least an individually packaged hair treatment composition comprising an oxidizing agent and an individually packaged hair treatment composition comprising an alkalizing agent and a persulfate salt.

16. A kit-of-parts according to claim 14, wherein said kit further comprises means to mix or to load said individually packaged hair treatment compositions into said hair treatment application device.

17. A kit-of-parts according to claim 14, wherein said kit further comprises instruction for consumers indicating how to load or use said hair treatment application device.
